(19) United States
(12) Patent Application Publication
(10) Pub. No.: US 2016/0253715 A1
(43) Pub. Date: Sep. 1, 2016

(54) Hashtags and Content Presentation

(71) Applicant: Google Inc., Mountain View, CA (US)

(72) Inventors: Yuanying Xie, Mountain View, CA (US); Sofia Andrianakou, Mountain View, CA (US)

(21) Appl. No.: 14/342,113

(22) PCT Filed: Nov. 4, 2013
(86) PCT No.: PCT/GR2013/000052

§ 371 Date: Feb. 28, 2014

(51) Int. Cl. G06Q 30/02; G06Q 50/00

(52) U.S. Cl. CPC G06Q 30/0276; G06Q 50/01

(57) ABSTRACT

Methods, systems, and apparatus include computer programs encoded on a computer-readable storage medium for using hashtags. A method includes: receiving input from a content sponsor for use in creating a campaign, the campaign having one or more associated selection criteria and a creative, wherein the selection criteria are used in evaluating when to serve the creative in response to received requests for content, and wherein the input is of the form of a keyword, a concept or a characteristic of a group of entities; identifying one or more hashtags using the input; presenting the one or more hashtags to the content sponsor; receiving input of a selected one of the one or more hashtags from the content sponsor; and using the selected one of the one or more hashtags as one of the one or more selection criteria for the campaign.

### BACKGROUND

This specification relates to information presentation.

The Internet provides access to a wide variety of resources. For example, video and/or audio files, as well as web pages for particular subjects or particular news articles, are accessible over the Internet. Access to these resources presents opportunities for other content (e.g., advertisements) to be provided with the resources. For example, a web page can include slots in which content can be presented. These slots can be defined in the web page or defined for presentation with a web page, for example, along with search results.

Slots can be allocated to content sponsors through a reservation system or an auction. For example, content sponsors can provide bids specifying amounts that the sponsors are respectively willing to pay for presentation of their content. In turn, a reservation can be made or an auction can be performed, and the slots can be allocated to sponsors according, among other things, to their bids and/or the relevance of the sponsored content to content presented on a page hosting the slot or a request that is received for the sponsored content.

### SUMMARY

In general, one innovative aspect of the subject matter described in this specification can be implemented in methods that include a method for using hashtags. A method includes: receiving input from a content sponsor for use in creating a campaign, the campaign having one or more associated selection criteria and a creative, wherein the selection criteria are used in evaluating when to serve the creative in response to received requests for content, and wherein the input is of the form of a keyword, a concept or a characteristic of a group of entities; identifying one or more hashtags using the input; presenting the one or more hashtags to the content sponsor; receiving input of a selected one of the one or more hashtags from the content sponsor; and using the selected one of the one or more hashtags as one of the one or more selection criteria for the campaign.

Another method includes: receiving input from an entity of the form of a keyword, a concept or a characteristic of a group of entities; identifying one or more hashtags using the input; presenting the one or more hashtags to the entity; receiving input of a selected one of the one or more hashtags from the entity; and using the selected one of the one or more hashtags in determining content to present to a user in response to received requests for content.

In general, another aspect of the subject matter described in this specification can be implemented in computer program products. A computer program product is tangibly embodied in a computer-readable storage device and comprises instructions. The instructions, when executed by a processor, cause the processor to: receive input from a content sponsor for use in creating a campaign, the campaign having one or more associated selection criteria and a creative, wherein the selection criteria are used in evaluating when to serve the creative in response to received requests for content, and wherein the input is of the form of a keyword, a concept or a characteristic of a group of entities; identify one or more hashtags using the input; present the one or more hashtags to the content sponsor; receive input of a selected one of the one or more hashtags from the content sponsor; and use the selected one of the one or more hashtags as one of the one or more selection criteria for the campaign.

These and other implementations can each optionally include one or more of the following features. The characteristic can be a demographic characteristic. Identifying one or more hashtags can include identifying one or more hashtags that are trending as most active in a group associated with the characteristic. Presenting the one or more hashtags can include presenting a list of most active hashtags for the group. Using the one of the one or more hashtags can include evaluating received requests for content that are related to a communication that includes the one of the one or more hashtags and providing the creative responsive to the request. Using the one of the one or more hashtags can include evaluating received requests for content to determine when they are related to a communication that includes the one of the one or more hashtags and providing the creative responsive to the request. Presenting the one or more hashtags includes presenting a user interface that includes the one or more hashtags, related hashtags and a tool for discovering more hashtags or information about a hashtag. The user interface can include a list of trending hashtags based on popularity. The user interface can include statistical information on use of the one or more hashtags in communications. The campaign can be automatically created based only on the input. The entity can be a publisher of a resource and the one of the one or more hashtags can be used as selection criteria for determining which content can be shown in a slot on a resource associated with the publisher. The entity can be an advertiser and the one of the one or more hashtags can be used as selection criteria in a campaign that presents content to users that are associated with the one of the one or more hashtags responsive to received requests for content.

Particular implementations may realize none, one or more of the following advantages. A content sponsor can associate one or more hashtags to use as selection criteria for a content campaign. A content campaign that includes hashtags associated with a keyword or concept can be automatically created for a content sponsor. A publisher can specify that content associated with a hashtag is allowable to be presented in a content slot on a resource associated with the publisher.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for presenting content.

FIG. 2 illustrates an example campaign management user interface.

FIG. 3 illustrates an example publisher user interface.

FIG. 4 is a block diagram of an example system for using hashtags.

FIGS. 5 and 6 are flowcharts of example processes for using hashtags.

FIG. 7 is a block diagram of computing devices that may be used to implement the systems and methods described in this document, as either a client or as a server or plurality of servers.

Like reference numbers and designations in the various drawings indicate like elements.

### DETAILED DESCRIPTION

A content sponsor can use one or more hashtags as selection criteria for a content campaign. A hashtag, as used herein, refers to a word or phrase that is prefixed with a non-alphabetic symbol (such as the # symbol). A hashtag can be used to index content, such as content that includes the hashtag. For example, a hashtag can be used in content used in social networking sites. Hashtags provide a ready means for grouping content, so as to enable ease of location of content that includes the tagged material. A content server can receive a keyword or concept input from a content sponsor for use in creating a campaign. The content server can identify one or more hashtags using the input and can present the one or more hashtags to the content sponsor. The content server can receive input of a selected hashtag from the content sponsor and can use the selected hashtag as selection criteria for the campaign. For example, the content server can evaluate received requests for content, determine that a request is related to a communication that includes the hashtag, and provide a creative included in the campaign in response to the request.

For situations in which the systems discussed here collect information about users, or may make use of information about users, the users may be provided with an opportunity to control whether programs or features collect user information (e.g., information about a user's social network, social actions or activities, profession, demographics, a user's preferences, or a user's current location), or to control whether and/or how to receive content from the content server that may be more relevant to the user. In addition, certain data may be treated in one or more ways before it is stored or used, so that certain information about the user is removed. For example, a user's identity may be treated so that no identifying information can be determined for the user, or a user's geographic location may be generalized where location information is obtained (such as to a city, ZIP code, or state level), so that a particular location of a user cannot be determined. Thus, the user may have control over how information about the user is collected and used by a content server.

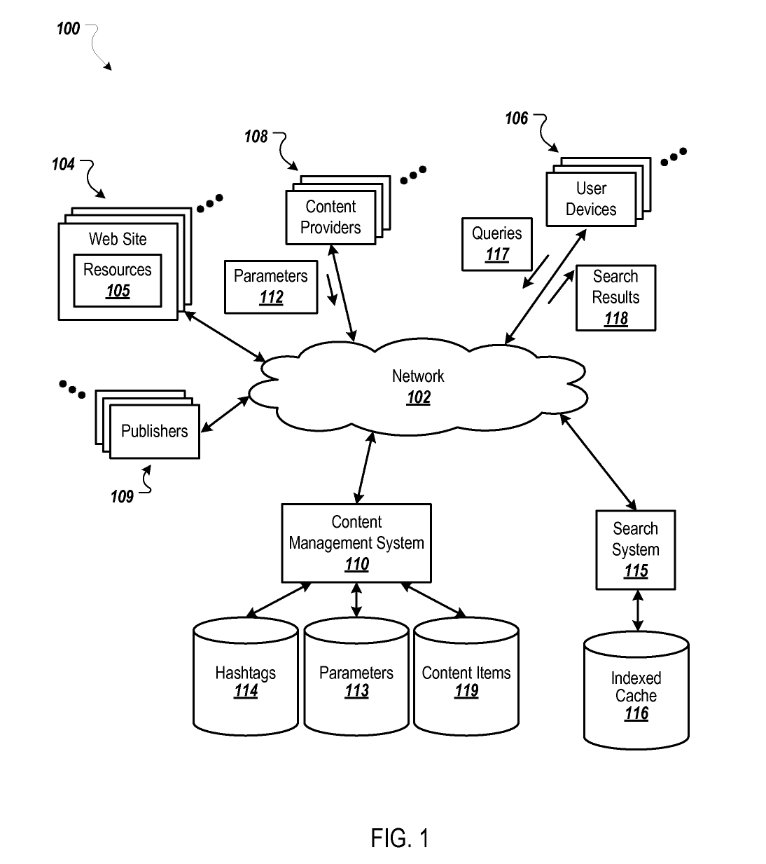

FIG. 1 is a block diagram of an example environment 100 for providing content to a user. The example environment 100 includes a network 102, such as a local area network (LAN), a wide area network (WAN), the Internet, or a combination thereof. The network 102 connects websites 104, user devices 106, content providers 108, publishers 109, and a content management system 110. The example environment 100 may include many thousands of websites 104, user devices 106, content providers 108, and publishers 109. The content management system 110 may be used for selecting and providing content in response to requests for content. The content providers 108 can be, for example, advertisers. Other types of content providers are possible.

A content provider 108 or content sponsor can create a content campaign associated with one or more content items using tools provided by the content management system 110. For example, the content management system 110 can provide one or more account management user interfaces for creating and managing content campaigns. The account management user interfaces can be made available to the content provider 108, for example, either through an online interface provided by the content management system 110 or as an account management software application installed and executed locally at a content provider's client device.

A content provider 108 can, using the account management user interfaces, provide campaign parameters 112 which define a content campaign. The content campaign can be created and activated for the content provider 108 according to the parameters 112 specified by the content provider 108. The campaign parameters 112 can be stored in a campaign database 113. Campaign parameters 112 can include, for example, a campaign name, a preferred content network for placing content, a budget for the campaign, start and end dates for the campaign, a schedule for content placements, content (e.g., creatives), bids, and selection criteria. Selection criteria can include, for example, a language, one or more geographical locations or websites, and/or one or more selection terms. The selection terms, can include, for example, one or more keywords and/or hashtags. The selection terms can be used in evaluating when to serve content items in response to received requests for content.

As discussed above, the selection terms can include one or more hashtags. A hashtag is a metadata tag that can be included in or appended to content. An example hashtag is a word or phrase prefixed with the “#” symbol, such as “#running”. As another example, a hashtag can be associated with a brand. For example, #CompanyName or #Brand can be hashtags. A hashtag can be used to group content items that include the hashtag. For example, a search can be performed for all content items that include “#running”.

The content management system 110 can provide tools to help a content provider 108 discover hashtags to include in a campaign. For example, the content provider 108 can provide an input, such as a keyword, concept, or characteristic (e.g., demographic characteristic or industry/vertical characteristic). The content management system 110 can identify one or more hashtags using the input, such as from a hashtags database 114. For example, when the input is a keyword, the content management system 110 can identify hashtags that are related to the keyword. The identified hashtags can be presented to the content provider 108 in a user interface, and the content provider 108 can select one or more presented hashtags for inclusion in the campaign. The selected one or more hashtags can be used as selection criteria for the campaign. Using hashtags as selection criteria is discussed in more detail below.

A website 104 includes one or more resources 105 associated with a domain name and hosted by one or more servers. An example website 104 is a collection of web pages formatted in hypertext markup language (HTML) that can contain text, images, multimedia content, and programming elements, such as scripts. Each website 104 can be maintained by a publisher 109, which is an entity that controls, manages and/or owns the website 104.

A resource 105 can be any data that can be provided over the network 102. A resource 105 can be identified by a resource address that is associated with the resource 105. Resources 105 include HTML pages, word processing documents, portable document format (PDF) documents, images, video, and news feed sources, to name only a few. The resources 105 can include content, such as words, phrases, videos, images and sounds, that may include embedded information (such as meta-information hyperlinks) and/or embedded instructions (such as scripts).

A user device 106 is an electronic device that is under control of a user and is capable of requesting and receiving resources 105 over the network 102. Example user devices 106 include personal computers, tablet computers, mobile communication devices (e.g., smartphones), televisions, set top boxes, personal digital assistants and other devices that can send and receive data over the network 102. A user device 106 typically includes one or more user applications, such as a web browser, to facilitate the sending and receiving of data over the network 102. The web browser can interact with various types of web applications, such as a game, a map application, or an e-mail application, to name a few examples.

A user device 106 can request resources 105 from a website 104. In turn, data representing the resource 105 can be provided to the user device 106 for presentation by the user device 106. User devices 106 can also submit search queries 117 to the search system 115 over the network 102. In response to a search query 117, the search system 115 can, for example, access the indexed cache 116 to identify resources 105 that are relevant to the search query 117. The search system 115 identifies the resources 105 in the form of search results 118 and returns the search results 118 to the user devices 106 in search results pages. A search result 118 is data generated by the search system 115 that identifies a resource 105 that is responsive to a particular search query 117, and includes a link to the resource 105. An example search result 118 can include a web page title, a snippet of text or a portion of an image extracted from the web page, and the URL (Unified Resource Location) of the web page.

The data representing the resource 105 or the search results 118 can also include data specifying a portion of the resource 105 or search results 118 or a portion of a user display (e.g., a presentation location of a pop-up window or in a slot of a web page) in which other content (e.g., advertisements) can be presented. These specified portions of the resource or user display are referred to as slots or impressions. An example slot is an advertisement slot. In some implementations, the publisher 109 of a resource 105 can specify (e.g., using a publisher account management interface associated with the content management system 110) one or more hashtags to use as selection criteria for determining which content can be shown in a slot on a resource 105 associated with the publisher 109. Using hashtags as selection criteria is discussed in more detail below.

When a resource 105 or search results 118 are requested by a user device 106, the content management system 110 may receive a request for content to be provided with the resource 105 or search results 118. The request for content can include characteristics of one or more slots or impressions that are defined for the requested resource 105 or search results 118. For example, a reference (e.g., URL) to the resource 105 or search results 118 for which the slot is defined, a size of the slot, and/or media types that are available for presentation in the slot can be provided to the content management system 110. Similarly, keywords and/or hashtags associated with a requested resource 105 or a search query 117 for which search results 118 are requested can also be provided to the content management system 110 to facilitate identification of content that is relevant to the resource 105 or search query 117. An identifier (e.g., cookie) associated with the user device 106 can be received with the request for content.

Based, for example, on data included in the request for content, the content management system 110 can select (e.g., from a content items data store 119) content items that are eligible to be provided in response to the request. One or more selected content items can be provided to the user device 106 in association with providing an associated resource 105 or search results 118. The provided content item(s) can be presented on the user device 106, in one or more respective slots.

The content management system 110 can, for example, select a content item having characteristics matching the characteristics of a given slot. As another example, content items having selection criteria (e.g., keywords, hashtags) that match resource keywords or hashtags, in the search query 117, or keywords or hashtags included in the search results 118 may be selected as eligible content items by the content management system 110. As yet another example, the content management system 110 can identify a content item in the content items datastore 119 that is associated with a hashtag or keyword that matches a hashtag or keyword included in a user profile associated with the requesting user device 106. The identified content item can be selected by the content management system 110 and provided to the requesting user device 106.

In some implementations, the content management system 110 can select content items based at least in part on results of an auction. For example, content providers 108 can provide bids specifying amounts that the content providers 108 are respectively willing to pay for presentation of their content items. In turn, an auction can be performed and the slots can be allocated to content providers 108 according, among other things, to their bids and/or the relevance of a content item to content presented on a page hosting the slot or a request that is received for the content item. For example, when a slot is being allocated in an auction, the slot can be allocated to the content provider 108 that provided the highest bid or a highest auction score (e.g., a score that is computed as a function of a bid and/or a quality measure). A quality score can be determined, for example, based on a quality of match between, for example, a keyword or hashtag associated with a content item and keywords or hashtags associated with a resource that includes the slot associated with the request. As another example, a quality score can be determined based on a quality of match between a keyword or hashtag associated with a content item and keywords or hashtags included in a user device profile associated with the requesting user device.

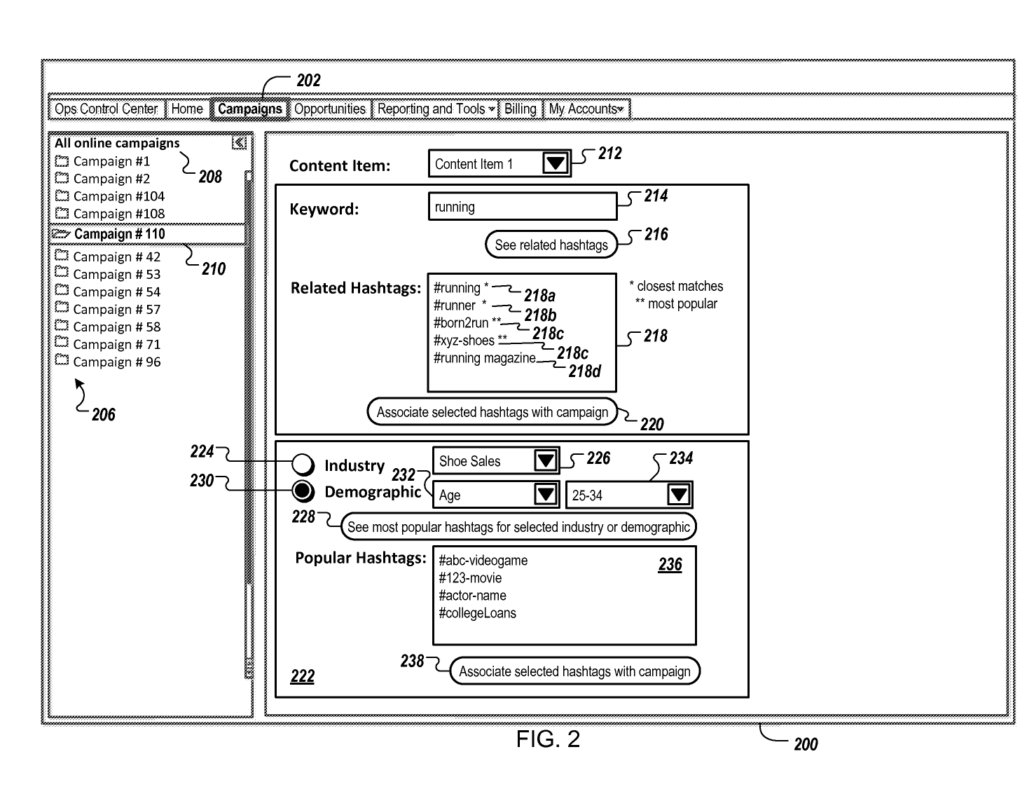

FIG. 2 illustrates an example campaign management user interface 200. The user interface 200 can be included, for example, in one or more user interfaces that a user, such as a content sponsor, can use to configure a campaign. The content sponsor can select a tab 202 to display a campaign configuration area 204. The content sponsor can view a list 206 of campaigns by selecting a control 208. The content sponsor can edit an existing campaign in the campaign configuration area 204 by selecting the name of an existing campaign (e.g., a name 210) in the campaign list 206 or alternatively can create a new campaign. The content sponsor can select a content item for the campaign using a control 212.

Input can be provided by the content sponsor associated with the proposed campaign. For example, the content sponsor can provide a keyword to be associated with the campaign using a control 214. For example, a keyword of “running” has been provided by the content sponsor. The content sponsor can select a control 216 to view a set of hashtags that are related to the provided input (e.g., keyword). For example, hashtags related to the provided keyword of “running” are displayed in a control 218. For example, the control 218 respectively includes hashtags 218a-218e of “#running”, “#runner”, “#born2run”, “#xyz-shoes”, and “#running magazine”. The “#running” hashtag 218a and the “#runner” hashtag 218b are marked as closest matches to the provided keyword. The “#born2run” hashtag 218c and the “#xyz-shoes” hashtag 218d are marked as most popular hashtags. The content sponsor can select one or more of the displayed hashtags 218a-218e and can associate the selected hashtags with the content campaign by selecting a control 220. The content sponsor can as well refine the set of hashtags or otherwise view other hashtags associated with the set.

As another example, the content sponsor can use controls in a control area 222 to discover popular (e.g., trending) hashtags and to add popular hashtags to the campaign. For example, the content sponsor can select a control 224, select an industry (e.g., shoe sales) using a control 226, and select a control 228 to view popular hashtags corresponding to the selected industry. As another example, the content sponsor can select a control 230, select a demographic characteristic (e.g., age) using a control 232, select a characteristic value or range (e.g., twenty five to thirty four) using a control 234, and select the control 228 to view popular hashtags associated with the selected demographic value or range. For example, a control 236 displays a list of popular hashtags associated with the age range of twenty five to thirty four. The content sponsor can select one or more of the hashtags displayed in the control 236 and can associate the selected hashtags with the campaign by selecting a control 238. Other controls are possible. For example, popularity may be global (across plural different websites, or plural social sites) or can be specific to a targeted segment (e.g., in a specific demographic on a particular site).

In some implementations, a content sponsor can select a hashtag and can select a control (not shown) to view additional information about the hashtag. For example, descriptive information about the use by others of the hashtags along with performance information or statistical information on use of the hashtag in advertising can be presented. For example, estimated performance statistics including CPC (cost per click), clicks, impressions, CTR (click through rate), and quality score can be presented.

In some implementations, a campaign can be automatically created for a content sponsor based on an input of a keyword, concept, or characteristic (e.g., demographic, industry). For example, the content sponsor can provide a keyword and a set of hashtags can be identified that relate to the keyword. In some implementations, a set of keywords related to the provided keyword can also be identified. A campaign can be automatically created and the identified hashtags and the identified keywords can be associated with the campaign as selection criteria for the campaign.

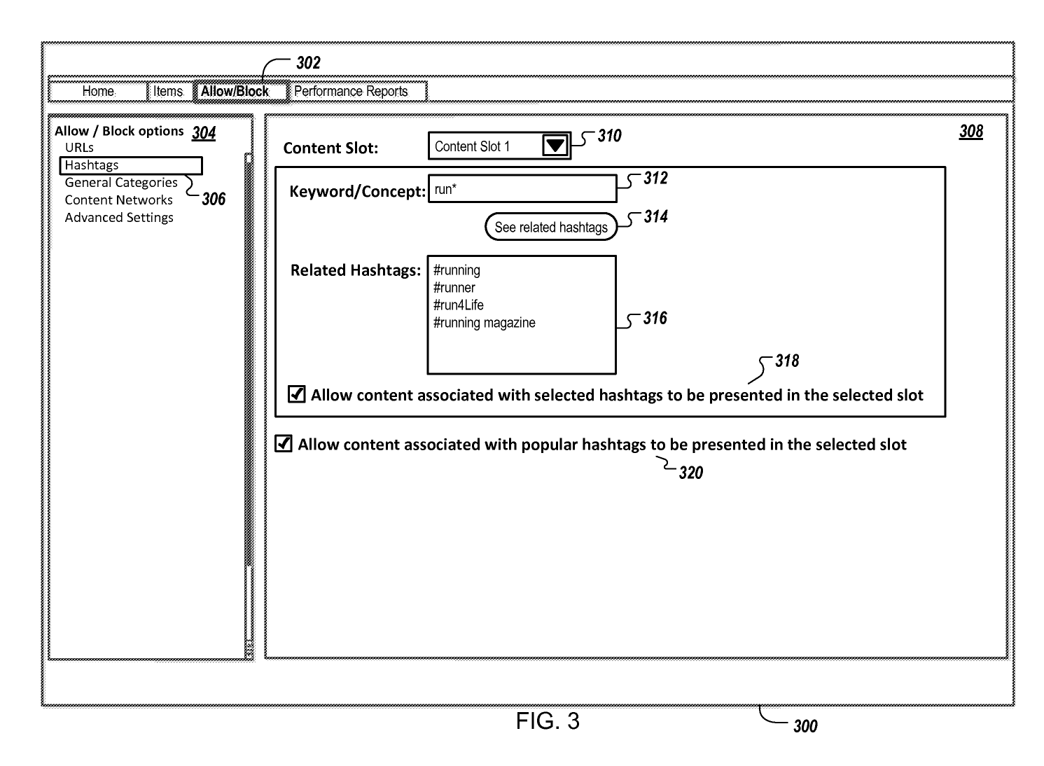

FIG. 3 illustrates an example publisher user interface 300. A publisher can select a tab 302 to configure types of content to allow in or block from a content slot on a resource associated with the publisher. The publisher can select an item in an options pane 304, such as to configure the allowing or blocking of content associated with particular URLs (Uniform Resource Locators), hashtags, content categories, or content networks, to name a few examples. For example, the publisher can select an item 306 to configure the allowing or blocking of content associated with hashtags, such as by using controls included in an area 308.

The publisher can select a particular content slot using a control 310. A keyword or concept input can be specified using a control 312. For example, a keyword of “run*” has been provided by the publisher, where the “*” is a wildcard character input. The publisher can select a control 314 to view a set of hashtags that are related to the provided keyword or concept. For example, hashtags related to the provided keyword of “run*” are displayed in a control 316. The publisher can select one or more of the displayed hashtags and can allow content associated with the selected hashtags to be presented in the selected slot by selecting a control 318. As another example, the content sponsor can allow content associated with popular hashtags to be presented in the selected slot by selecting a control 320. In some implementations, the publisher can view hashtags that are associated with a particular demographic characteristic or industry, select one or more of the displayed hashtags, and allow/or disallow content associated with the selected hashtag(s) to be presented in the selected slot.

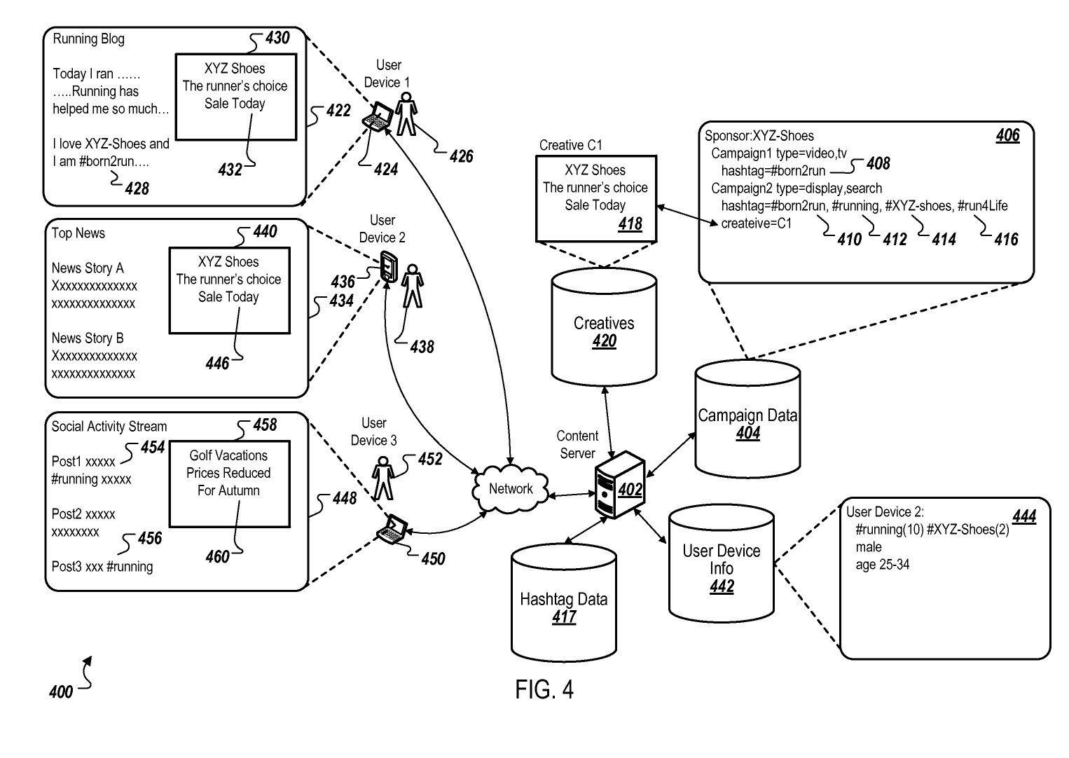

FIG. 4 is a block diagram of an example system 400 for using hashtags. A content server 402 manages campaign data 404 for content sponsors, including a content sponsor “XYZ Shoes”. For instance, the campaign data 404 includes example campaign data 406 for the XYZ Shoes content sponsor. The campaign data 406 indicates that the content sponsor XYZ Shoes has two campaigns, including a first campaign “Campaign1”, that is a television and online video campaign that is associated with a campaign hashtag 408 of “#born2run”. For example, the content sponsor XYZ Shoes may include and promote the campaign hashtag “#born2run” in the campaign “Campaign1” (e.g., in presented video content).

A second campaign, “Campaign2”, is associated with the XYZ Shoes content sponsor, and is a display and search campaign. The second campaign is associated with the hashtags “#born2run” 410, “#running” 412, “#XYZ-Shoes” 414, and “#run4Life” 416. The content sponsor XYZ Shoes may have, for example, provided (e.g., inputted) the hashtag 410 to the content server 402 as a hashtag to associate with the second campaign. For example, the XYZ Shoes content sponsor may desire to present content associated with the second campaign to users who are associated with or have activity related to the first campaign (e.g., as indicated by such users being associated with communications that include or are associated with the #born2run hashtag). As another example, the XYZ Shoes content sponsor may desire to present second-campaign content in association with other content that is associated with the #born2run campaign hashtag.

The XYZ Shoes content sponsor may have also provided (e.g., inputted) the hashtag 414 as a selection criterion for the second campaign. The hashtags 412 and 416 may have been selected by the XYZ Shoes content sponsor from a list of presented hashtags. For example, the XYZ Shoes content sponsor may have provided a keyword input of “running” and may have selected the hashtags 412 and 416 from a presented list of hashtags related to the “running” keyword (e.g., with the presented list of hashtags being determined based on hashtag data 417).

The second campaign includes a creative “C1”. For instance, the example campaign data 406 can reference a creative 418 included in a creatives datastore 420. The content server 402 can serve the creative 418 based on the hashtags 410-416 and on other factors, such as other selection criteria.

For example, a running blog web page 422 is presented on a user device 424 of a user 426. The content of the web page 422 includes a #born2run hashtag 428. The web page 422 includes a content slot 430. A request for content associated with the content slot 430 can be sent to the content server 402. The content server 402 can select the creative 418 in response to the request for content, based, for example, on the second campaign including the hashtag 410 as selection criteria and the hashtag 428 being included in the content of the web page 422. The creative 418 can be sent to the user device 424 and presented in the content slot 430, as illustrated by a creative 432.

As another example, a news web page 434 is presented on a user device 436 of a user 438. The web page 434 does not include any hashtags. The web page 434 includes a content slot 440. The publisher of the web page 440 has specified (e.g., using a publisher user interface provided by the content server 402) that the publisher allows or desires content associated with the hashtag #running to be presented in the content slot 440. For example, the #running hashtag may have been selected by the publisher as a popular/trending hashtag.

A user device database 442 includes a profile 444 associated with the user device 436. The profile 444 indicates that the user device 436 is associated with activity that is associated with a male user aged twenty five to thirty four. The profile 444 also indicates that activity performed using the user device 436 is associated with the #running hashtag and with the #XYZ-Shoes hashtag (i.e., the user has posted one or several messages that includes the hashtags). A frequency count of ten is associated with the #running hashtag and a frequency count of two is associated with the XYZ-Shoes hashtag (e.g., content including the #running hashtag may have been presented ten times on the user device 436, or the user device 436 may have been used ten times to provide the hashtag #running, such as in communications performed using the user device 436).

A request for content for the content slot 440 can be sent to the content server 402, in association with the presenting of the web page 434. The content server 402 can select the creative 418 in response to the request, based, for example, on the creative 418 being included in the second campaign that has the #running hashtag as a selection criterion and the publisher of the web page 434 specifying that content related to the #running keyword is desirable or allowable to be presented in the content slot 440. As another example, the content server 402 can select the creative 418 based on the request for content being associated with the user device 436, the profile 444 associated with the user device 436 including the #running hashtag with a frequency of ten, and the creative 418 being included in the second campaign that has the #running hashtag as a selection criterion. The creative 418 can be sent to the user device 436 and presented in the content slot 440, as illustrated by a creative 446.

As yet another example, a social activity stream web page 448 is presented on a user device 450 of a user 452. The web page 448 includes social posts made using the user device 450. A #running hashtag 454 is included in a first post and a #running hashtag 456 is included in a third post. The web page 448 includes a content slot 458. A request for content for the content slot 458 can be sent to the content server 402. The content server 402 can select the creative 418 in response to the request, based, for example, on the web page 448 including the #running hashtags 454 and 456 and on the creative 418 being included in the second campaign that has the #running hashtag as a selection criterion. The creative 418 can be sent to the user device 450 and presented in the content slot 458, as illustrated by a creative 460.

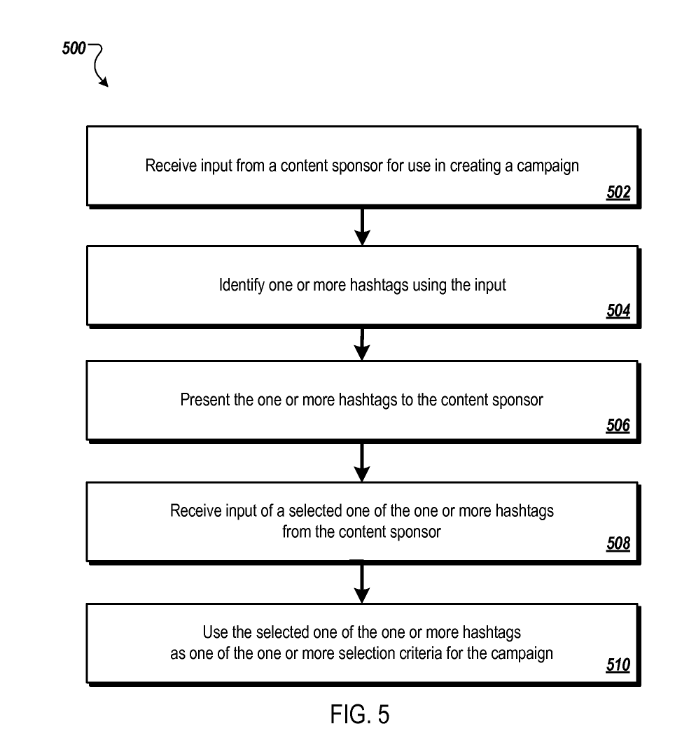

FIG. 5 is a flowchart of an example process 500 for using hashtags. The process 500 can be performed, for example, by the content management system 110 described above with respect to FIG. 1.

Input from a content sponsor for use in creating a campaign is received (502). The campaign can have one or more associated selection criteria and a creative. The selection criteria can be used in evaluating when to serve the creative in response to received requests for content. The input can be, for example, of the form of a keyword, a concept or a characteristic of a group of entities. The creative can be, for example, an advertisement. Other types of creatives can be used. The characteristic can be, for example, a demographic characteristic.

One or more hashtags are identified using the input (504). For example, when the input is a characteristic (e.g., a demographic characteristic), the one or more identified hashtags can be hashtags that are trending as most active in a group associated with the characteristic. As another example, when the input is a keyword or a concept, the one or more identified hashtags can be hashtags that are related to the keyword or the concept or related to another identified hashtag.

The one or more hashtags are presented to the content sponsor (506). For example, the one or more hashtags can be presented in a user interface. When the one or more identified hashtags are trending hashtags, a list of the most active hashtags in the group can be presented. The user interface can present, along with the identified hashtags, one or more hashtags that are related to the identified hashtags. The user interface can include one or more controls that when selected can enable the discovery of additional hashtags (e.g., hashtags related to a selected hashtag). The user interface can be configured to present information (e.g., statistical information) for a selected hashtag or for each of the identified hashtags.

Input of a selection one of the one or more hashtags is received from the content sponsor (508). For example, a selection user input can be received by the user interface.

The selected one of the one or more hashtags is used as one of the one or more selection criteria for the campaign (510). For example, received requests for content can be evaluated and a determination can be made that a request is related to a communication that includes the one of the one or more hashtags. In response to the determination, the creative can be provided responsive to the request.

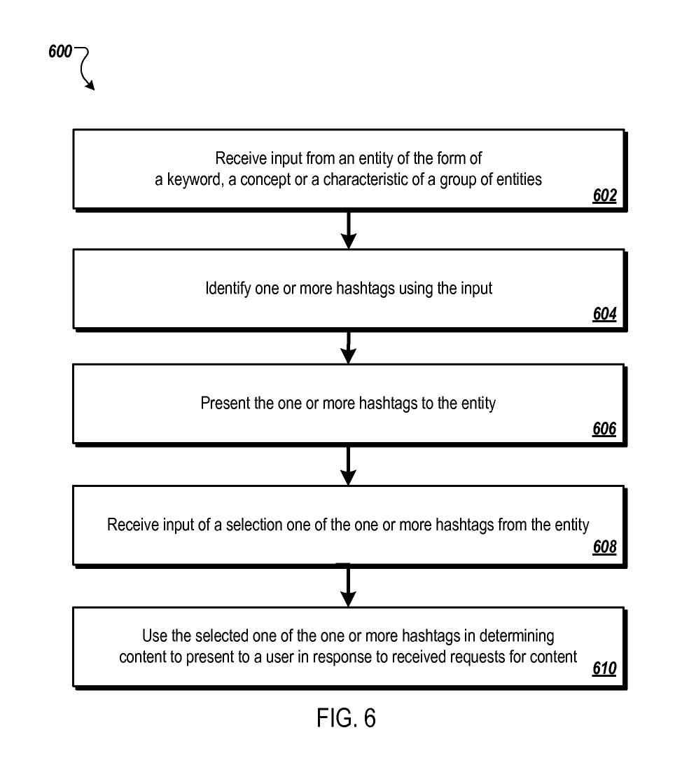

FIG. 6 is a flowchart of an example process 600 for using hashtags. The process 600 can be performed, for example, by the content management system 110 described above with respect to FIG. 1.

Input from an entity is received of the form of a keyword, a concept or a characteristic of a group of entities (602). The entity can be, for example, a publisher or a content sponsor (e.g., advertiser). The characteristic can be, for example, a demographic characteristic.

One or more hashtags are identified using the input (604). For example, when the input is a characteristic (e.g., a demographic characteristic), the one or more identified hashtags can be hashtags that are trending as most active in a group associated with the characteristic. As another example, when the input is a keyword or a concept, the one or more identified hashtags can be hashtags that are related to the keyword or the concept or related to another identified hashtag.

The one or more hashtags are presented to the entity (606). For example, the one or more hashtags can be presented in a user interface. When the one or more identified hashtags are trending hashtags, a list of the most active hashtags in the group can be presented. The user interface can present, along with the identified hashtags, one or more hashtags that are related to the identified hashtags. The user interface can include one or more controls that when selected can enable the discovery of additional hashtags (e.g., hashtags related to a selected hashtag). The user interface can be configured to present information (e.g., statistical information) for a selected hashtag or for each of the identified hashtags.

Input of a selection one of the one or more hashtags is received from the entity (608). For example, a selection user input can be received using the user interface.

The selected one of the one or more hashtags is used in determining content to present to a user in response to received requests for content (610). For example, received requests for content can be evaluated and a determination can be made that a request is related to a communication that includes the one of the one or more hashtags. In response to the determination, the creative can be provided responsive to the request. As another example, when the entity is a publisher, the one of the one or more hashtags can be used as selection criteria for determining which content can be shown in a slot on a resource associated with the publisher. When the entity is a content sponsor (e.g., advertiser), the one of the one or more hashtags can be used as selection criteria in a campaign that presents content to users that are associated with the one of the one or more hashtags responsive to received requests for content.

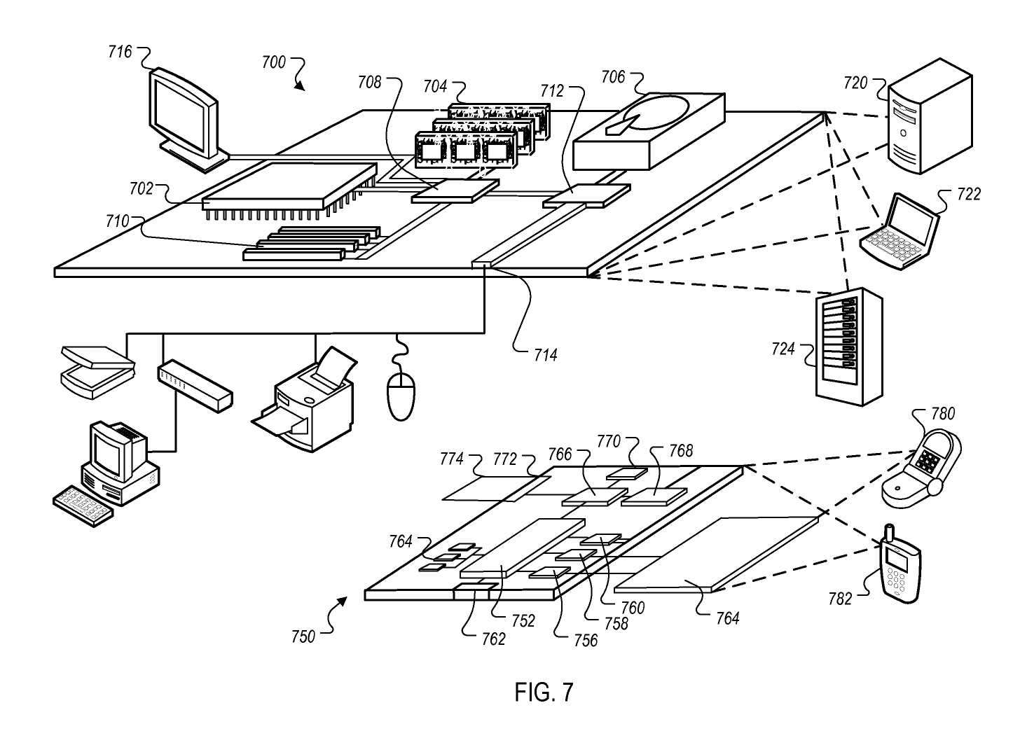

FIG. 7 is a block diagram of computing devices 700, 750 that may be used to implement the systems and methods described in this document, as either a client or as a server or plurality of servers. Computing device 700 is intended to represent various forms of digital computers, such as laptops, desktops, workstations, personal digital assistants, servers, blade servers, mainframes, and other appropriate computers. Computing device 750 is intended to represent various forms of mobile devices, such as personal digital assistants, cellular telephones, smartphones, and other similar computing devices. The components shown here, their connections and relationships, and their functions, are meant to be illustrative only, and are not meant to limit implementations of the inventions described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a computer-readable medium. The computer-readable medium is not a propagating signal. In one implementation, the memory 704 is a volatile memory unit or units. In another implementation, the memory 704 is a non-volatile memory unit or units.

The storage device 706 is capable of providing mass storage for the computing device 700. In one implementation, the storage device 706 is a computer-readable medium. In various different implementations, the storage device 706 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 704, the storage device 706, or memory on processor 702.

The high speed controller 708 manages bandwidth-intensive operations for the computing device 700, while the low speed controller 712 manages lower bandwidth-intensive operations. Such allocation of duties is illustrative only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can process instructions for execution within the computing device 750, including instructions stored in the memory 764. The processor may also include separate analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT LCD display or an OLED display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may be provide in communication with processor 752, so as to enable near area communication of device 750 with other devices. External interface 762 may provide, for example, for wired communication (e.g., via a docking procedure) or for wireless communication (e.g., via Bluetooth® or other such technologies).

The memory 764 stores information within the computing device 750. In one implementation, the memory 764 is a computer-readable medium. In one implementation, the memory 764 is a volatile memory unit or units. In another implementation, the memory 764 is a non-volatile memory unit or units. Expansion memory 774 may also be provided and connected to device 750 through expansion interface 772, which may include, for example, a SIMM card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provide as a security module for device 750, and may be programmed with instructions that permit secure use of device 750. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, or memory on processor 752.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth®, WiFi, or other such transceiver (not shown). In addition, GPS receiver module 770 may provide additional wireless data to device 750, which may be used as appropriate by applications running on device 750.

Device 750 may also communicate audibly using audio codec 760, which may receive spoken information from a user and convert it to usable digital information. Audio codex 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smartphone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, various forms of the flows shown above may be used, with steps re-ordered, added, or removed. Also, although several applications of the payment systems and methods have been described, it should be recognized that numerous other applications are contemplated. Accordingly, other embodiments are within the scope of the following claims.

What is claimed is:

1. A computer implemented method comprising:
receiving input from a content sponsor for use in creating a campaign, the campaign having one or more associated selection criteria and a creative, wherein the selection criteria are used in evaluating when to serve the creative in response to received requests for content, and wherein the input is of the form of a keyword, a concept or a characteristic of a group of entities;
identifying one or more hashtags using the input;
presenting the one or more hashtags to the content sponsor;
receiving input of a selected one of the one or more hashtags from the content sponsor; and
using the selected one of the one or more hashtags as one of the one or more selection criteria for the campaign.

2. The method of claim 1 wherein the characteristic is a demographic characteristic.

3. The method of claim 1 wherein identifying one or more hashtags includes identifying one or more hashtags that are trending as most active in a group associated with the characteristic.

4. The method of claim 3 wherein presenting the one or more hashtags includes presenting a list of most active hashtags for the group.

5. The method of claim 1 wherein using the one of the one or more hashtags includes evaluating received requests for content that are related to a communication that includes the one of the one or more hashtags and providing the creative responsive to the request.

6. The method of claim 1 wherein using the one of the one or more hashtags includes evaluating received requests for content to determine when they are related to a communication that includes the one of the one or more hashtags and providing the creative responsive to the request.

7. The method of claim 1 wherein presenting the one or more hashtags includes presenting a user interface that includes the one or more hashtags, related hashtags and a tool for discovering more hashtags or information about a hashtag.

8. The method of claim 7 wherein the user interface includes a list of trending hashtags based on popularity.

9. The method of claim 7 wherein the user interface includes statistical information on use of the one or more hashtags in communications.

10. The method of claim 1 further comprising automatically creating the campaign based only on the input.

11. A computer implemented method comprising:
receiving input from an entity of the form of a keyword, a concept or a characteristic of a group of entities;
identifying one or more hashtags using the input;
presenting the one or more hashtags to the entity;
receiving input of a selected one of the one or more hashtags from the entity; and
using the selected one of the one or more hashtags in determining content to present to a user in response to received requests for content.

12. The method of claim 11 wherein the characteristic is a demographic characteristic.

13. The method of claim 11 wherein identifying one or more hashtags includes identifying one or more hashtags that are trending as most active in a group associated with the characteristic.

14. The method of claim 11 wherein using the one of the one or more hashtags includes evaluating received requests for content that is related to a communication that includes the one of the one or more hashtags and providing content from a campaign that includes the one of the one or more hashtags as a selection criteria responsive to the received requests.

15. The method of claim 11 wherein using the one of the one or more hashtags includes evaluating received requests for content to determine when they are related to a communication that includes the one of the one or more hashtags and providing content from a campaign that includes the one of the one or more hashtags as a selection criteria responsive to the received requests.

16. The method of claim 11 wherein presenting the one or more hashtags includes presenting a user interface that includes the one or more hashtags, related hashtags and a tool for discovering more hashtags or information about a hashtag.

17. The method of claim 17 wherein the user interface includes a list of trending hashtags based on popularity.

18. The method of claim 11 wherein the entity is a publisher of a resource and the one of the one or more hashtags are used as selection criteria for determining which content can be shown in a slot on a resource associated with the publisher.

19. The method of claim 11 wherein the entity is an advertiser and the one of the one or more hashtags are used as selection criteria in a campaign that presents content to users that are associated with the one of the one or more hashtags responsive to received requests for content.

20. A computer program product tangibly embodied in a computer-readable storage device and comprising instructions that, when executed by a processor, cause the processor to:
receive input from a content sponsor for use in creating a campaign, the campaign having one or more associated selection criteria and a creative, wherein the selection criteria are used in evaluating when to serve the creative in response to received requests for content, and wherein the input is of the form of a keyword, a concept or a characteristic of a group of entities;
identify one or more hashtags using the input;
present the one or more hashtags to the content sponsor;
receive input of a selected one of the one or more hashtags from the content sponsor; and
use the selected one of the one or more hashtags as one of the one or more selection criteria for the campaign.
